(19) United States
(12) Patent Application Publication
(10) Pub. No.: US 2017/0214882 A1
(43) Pub. Date: Jul. 27, 2017

(54) REMOTE MANAGEMENT OF MULTI-STREAM RECORDINGS AND ASSOCIATED SYSTEMS AND METHODS

(71) Applicant: Panopto, Inc., Seattle, WA (US)

(72) Inventors: Eric Burns, Seattle, WA (US); Michael Guthmann, Seattle, WA (US); Andi Fein, Seattle, WA (US); Bryan Kraus, Seattle, WA (US); Timothy Sullivan, Seattle, WA (US)

(21) Appl. No.: 15/418,446

(22) Filed: Jan. 27, 2017

Related U.S. Application Data
(60) Provisional application No. 62/287,814, filed on Jan. 27, 2016.

(51) Int. Cl. H04N 5/77; H04N 5/232; G11B 27/36; H04N 7/18

(52) U.S. Cl. CPC H04N 5/77; H04N 7/181; H04N 5/23293; H04N 5/23203; G11B 27/36; G06F 3/0482

(57) ABSTRACT

Systems and methods are provided for remotely managing multi-stream recordings. After authenticating the log-in of a user, such as from a mobile computing device running a mobile application, the system identifies multi-stream recorders that are accessible to the user. The system displays a preview of the accessible multi-stream recorders, such as through an interface generated by the mobile application. The user may then view additional details of the accessible multi-stream recorders, begin a recording at a multi-stream recorder, or manage a scheduled or current recording.

### CROSS-REFERENCE TO RELATED APPLICATION(S)

This application claims priority to U.S. Patent Application No. 62/287,814, entitled “REMOTE MANAGEMENT OF MULTI-STREAM RECORDINGS AND ASSOCIATED SYSTEMS AND METHODS,” filed Jan. 27, 2016, the contents of which are incorporated herein by reference in its entirety.

### TECHNICAL FIELD

The present technology relates generally to access-aware systems and methods for remotely managing multi-stream recordings, such as from a mobile device.

### BACKGROUND

Commercial and institutional users, such as businesses and universities, increasingly record their presentations or other content. For example, businesses and universities may record classroom lectures, informational presentations, training sessions, or other meetings, thereby enabling the preservation and sharing of presentation content with others. Such recordings may be multi-stream, where a single recording includes audio and/or video captured from multiple sources. For example, a multi-stream recording of a classroom lecture may include video of the lecturer and a capture of content being displayed on a computer during the lecture (such as presentation slides). As a further example, a multi-stream recording of a presentation may include video of the presenter and video of the audience. Oftentimes, businesses and universities have multiple lecture halls, classrooms, conference rooms, training rooms, etc. configured for multi-stream recording.

The known methods by which users manage multi-stream recordings leave much to be desired. For example, users may be required to initiate recordings directly at the recording equipment, schedule recordings in advance, or utilize a recording management interface lacking certain features. In a further example, specialized audio/visual technicians, located on-site, may be required to initiate and manage recordings. It would therefore be beneficial to be able to conveniently and easily manage multi-stream recordings in a manner that cures these and other shortcomings.

### BRIEF DESCRIPTION OF THE DRAWINGS

FIG. 1 is a diagram of an example environment in which a system for remote management of multi-stream recordings may operate.

FIG. 2 is a flow diagram of a process for remotely managing a multi-stream recording.

FIG. 3 is an example graphical user interface for viewing accessible remote multi-stream recorders.

FIG. 4 is an example graphical user interface for viewing details of a selected remote multi-stream recorder.

### DETAILED DESCRIPTION

The present technology relates generally to systems and methods for remotely managing multi-stream recordings, such as through a mobile device. A multi-stream recording is a single recording that includes audio and/or video from multiple (two or more) sources. For example, a multi-stream recording of a classroom lecture may include video of the lecturer and a capture of content being displayed on a computer during the lecture (such as presentation slides). As a further example, a multi-stream recording of a presentation may include video of the presenter and video of the audience. In one embodiment of the present technology, a user affiliated with a commercial or institutional entity logs in to a multi-stream recording remote management system through an application running on a mobile device. After the user's log-in is verified, the application displays a list of multi-stream accessible recorders (e.g., recorders associated with conference rooms of a business to which the user is affiliated) based on access permissions associated with the user and the utilization of the multi-stream recorders by other users. The list may include multi-stream recorders that are remote from the user (i.e., in a different physical location), but that may nonetheless be remotely managed through the application. As described herein the system is configured to determine those multi-stream recorders that the user is currently authorized to manage, and may list only the identified recorders, thereby providing secure use of shared multi-stream recording resources among multiple users.

Using the application the user may perform a variety of management functions over the multi-stream recorders, including viewing information on available multi-stream recorders, retrieving information on past, current, or pending recordings associated with a selected multi-stream recorder, and initiating a recording for streaming or for saving to a default location associated with the user. The management functions available to the user may additionally be based on the user's access permissions.

These and other aspects of the technology will be described in greater detail below. The following description provides specific details for a thorough understanding and an enabling description of the present technology. One skilled in the art will understand, however, that the present technology may be practiced without many of these details. Additionally, some well-known structures or features may not be shown or described in detail, so as to avoid unnecessarily obscuring the relevant description of the various aspects of the technology. The terminology used in the description presented below is intended to be interpreted in its broadest reasonable manner, even though it is being used in conjunction with a detailed description of certain specific embodiments of the technology.

### Suitable Environments and Systems

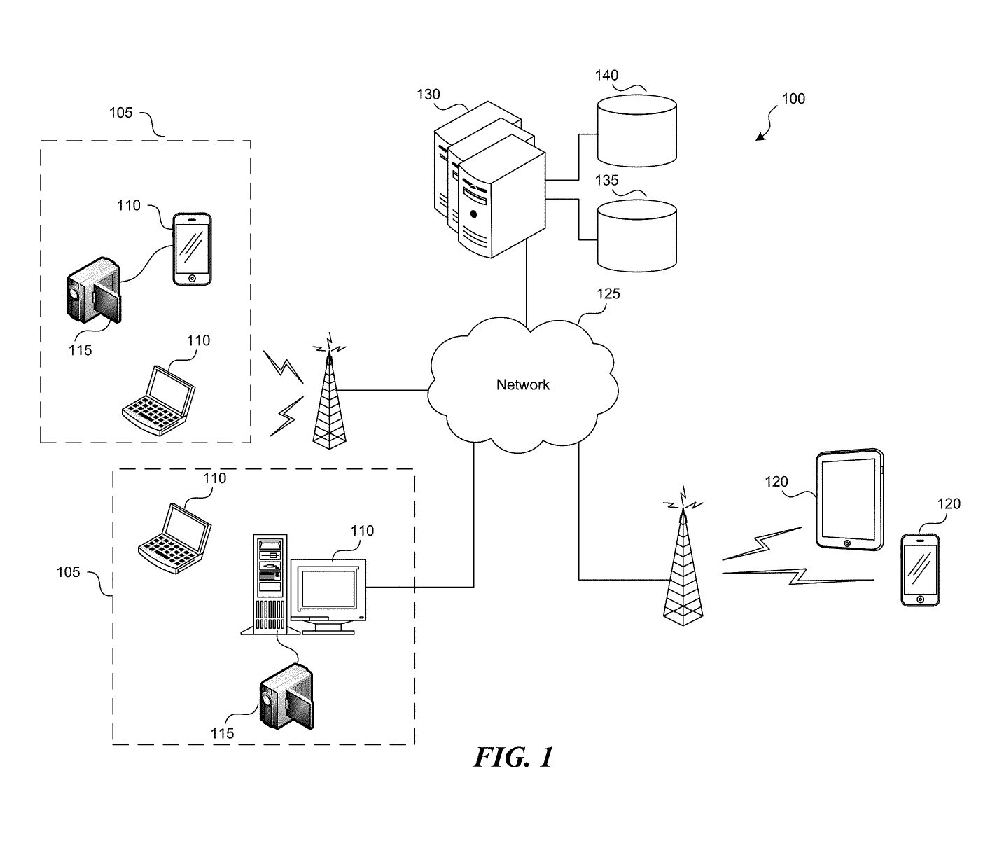

FIG. 1 and the following discussion provide a brief, general description of a suitable environment in which a system for the remote management of multi-stream recordings may be implemented. Although not required, aspects of the technology are described in the general context of computer-executable instructions, such as routines executed by a general-purpose computer, a personal computer, a server, or other computing system. The technology can also be embodied in a special purpose computer or data processor that is specifically programmed, configured, or constructed to perform one or more of the computer-executable instructions explained in detail herein. Indeed, the term “computer” and “computing device,” as used generally herein, refer to devices that have a processor and non-transitory memory, like any of the above devices, as well as any data processor or any device capable of communicating with a network. Data processors include programmable general-purpose or special-purpose microprocessors, programmable controllers, application-specific integrated circuits (ASICs), programming logic devices (PLDs), or the like, or a combination of such devices. Computer-executable instructions may be stored in memory, such as random access memory (RAM), read-only memory (ROM), flash memory, or the like, or a combination of such components. Computer-executable instructions may also be stored in one or more storage devices, such as magnetic or optical-based disks, flash memory devices, or any other type of non-volatile storage medium or non-transitory medium for data. Computer-executable instructions may include one or more program modules, which include routines, programs, objects, components, data structures, and so on that perform particular tasks or implement particular abstract data types.

Aspects of the technology can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or subroutines may be located in both local and remote memory storage devices. Aspects of the technology described herein may be stored or distributed on tangible, non-transitory computer-readable media, including magnetic and optically readable and removable computer discs, stored in firmware in chips (e.g., EEPROM chips). Alternatively, aspects of the technology may be distributed electronically over the Internet or over other networks (including wireless networks). Those skilled in the relevant art will recognize that portions of the technology may reside on a server computer, while corresponding portions reside on a client computer.

FIG. 1 illustrates a representative environment 100 in which aspects of the described technology may operate. The environment 100 includes, for example, one or more content recorders 110, one or more remote management devices 120, and remote management server 130. The remote management server 130 may include a content storage 135 and recording metadata 140. The content recorders 110, remote management devices 120, and remote management server 130 communicate with each other through network(s) 125 including, for example, the Internet. The content recorders 110 and remote management devices 120 may communicate wirelessly with a base station or access point using a wireless mobile telephone standard, such as the Global System for Mobile Communication (GSM), or another wireless standard, such as IEEE 802.11, and the base station or access point may communicate with the remote management server 130 via the network 125. Aspects of a multi-stream recording remote management system may be practiced by the one or more content recorders 110, remote management devices 120, and remote management server 130.

As illustrated, the system includes one or more content recorders 110 for capturing content to be included in a multi-stream recording. A content recorder 110 may be a mobile device, such as a mobile phone or tablet computer, connected to the network 125 through a wireless connection. A content recorder 110 may also be a laptop computer or desktop computer, connected to the network 125 through a wireless connection or a wired connection. Content recorders 110 may also be paired with a recording device 115, such as a video camera or microphone. Though illustrated as distinct devices, a recording device 115 may be integrated with a content recorder 110 (e.g., the built-in video camera of a mobile phone or tablet). Each content recorder 110 captures audio or visual content that may be included in a multi-stream recording. For example, a content recorder 110 paired to a recording device 115 may capture video via the recording device. As a further example, a content recorder 110 may capture content being displayed on, retrieved by, or stored on the content recorder 110 (e.g., a slide presentation being displayed on the content recorder, a webpage being accessed by the content recorder, an audio or video file being played by the content recorder, etc.).

One or more content recorders 110 may in combination form multi-stream recorders 105. A multi-stream recorder 105 includes the content from the associated content recorders 110 in the single multi-stream recording generated by the multi-stream recorder. For example, the recording from a multi-stream recorder 105 may include video from one content recorder 110 and web content from another content recorder 110. A multi-stream recorder 105 may correspond to a physical recording location, and each of the content recorders 110 that form the multi-stream recorder 105 may be located at that location. For example, each of the multi-stream recorders 105 may correspond to different classrooms, lecture halls, conference rooms, training rooms, or other locations where recording may be desired, and each of the associated content recorders 110 may be located at that classroom, lecture hall, conference room, training room, etc. Alternatively, a multi-stream recorder 105 may not correspond to a single physical location, and the content recorders 110 making up that multi-stream recorder 105 may be located at different locations.

Using a remote management device 120, a user may manage multi-stream recorders 105. The remote management device 120 may be, for example, a mobile computing device, such as a mobile phone or tablet computer, connected to the network 120 through a wireless connection. For example, the remote management device 120 may be a mobile phone belonging to the user and running an application through which multi-stream recorder remote management may be performed. The user may be affiliated with a business, university, or any other commercial or institutional entity at which multi-stream recorders 105 are located. For example, the user may be an employee of a business, a student or professor at a university, a member of IT staff, or another affiliated individual who has been given permission to remotely manage multi-stream recorders 105 at recording locations of the entity. The user may log in to the system, through an application on a remote management device 120, using a username and password provided by the system, a username and password associated with a user account at the entity (e.g., a university or corporate login), or with voice authentication.

The remote management device 120 may communicate with the remote management server 130 to facilitate management of the multi-stream recorders 105. For example, a user attempting to connect to the remote management system may enter user credentials at remote management device 120, which may be transmitted to the remote management server 130. The remote management server 130 may then validate the received user credentials, thereby authenticating the user.

After authenticating the user, access permissions associated with user account may be retrieved by the remote management server, such as from the recording metadata 140 or other storage area accessible to the server. As described herein, the retrieved access permissions facilitate the secure management of the multi-stream recorders in a multi-user environment. For example, the access permissions may control which multi-stream recorders 105 are accessible to the user (which may depend on whether the user should generally be permitted to access the multi-stream recorder, whether the recorder is currently in use or scheduled for use shortly, the user's current location, the current time and day, etc.). That is, a multi-stream recorder 105 that would otherwise be accessible to the user may be rendered inaccessible to the user at a particular time because the recorder is currently being managed (e.g., recording) by another user (as indicated, for example, by a schedule of recordings for each of the multi-stream recorders maintained as part of the recording metadata 140) or because the current time is outside the window during which the user is permitted to manage the recorder. In some embodiments, only those multi-stream recorders 105 determined by the system to be accessible by the user are provided to the remote management device 120. In other embodiments, both accessible and inaccessible multi-stream recorders may be provided to the remote management device 120, and inaccessible recorders may be indicated as such.

The remote management device 120 may generate a list of multi-stream recorders 105 for display to the user based on, for example, a list of accessible multi-stream recorders provided by the remote management server 130. As described herein, the user may remotely manage the multi-stream recorders 105, such as by entering management instructions into the remote management device 120. For example, the user may use a remote management device 120 to begin a recording at a multi-stream recorder 105. When a user initiates a recording at the remote management device 120, the remote management device 120 may send a scheduling update to the recording metadata 140 through the remote management server 130. Each multi-stream recorder 105 may, on a regular basis, poll the remote management server 130 to retrieve any updated schedule data corresponding to that multi-stream recorder. When a multi-stream recorder 105 determines it is scheduled to record, based on the retrieved schedule data, it will initiate recording. Once a recording begins, the recording may be uploaded by the multi-stream recorder 105 to a remote management server 130 via the network 125. The uploaded recording may then be saved in content storage 135. In addition to initiating recordings, other recording management functions may be performed by the user. For example, as described herein, the user may use the multi-stream recorder management system to schedule future recordings, to start a scheduling recording early, to stop a recording, to change metadata associated with a recording (e.g., title, description, presenter bio, etc.), to pause and resume an ongoing recording, to enable or disable specific streams of the multi-stream recording, and to augment the recording with supplementary information (e.g., live transcriptions, moderated audience questions, etc.). In addition to the management of recordings, the multi-stream recorder management system may enable remote management of the multi-stream recorders themselves. For example, the user may monitor the recording status of the multi-stream recorder, may modify which devices are used by the recorder (i.e., what streams are associated with recordings by the recorder), and other administrative functions (such as modifying all recordings scheduled for the recorder). As described herein, different management functions may be available to different users. For example, the access permissions may indicate which management functions are available to each user.

The permissions associated with a user, both with respect to which multi-stream recorders can be accessed by the user and which management functions are available to the user for the different multi-stream recorders, may be defined on an account-level for different user accounts maintained by the system. That is, in some embodiments, each user account may be explicitly characterized by the multi-stream recorders to which the user has access (including conditions, such as day and time) and available management functions over those recorders. In some embodiments, a user account may be associated with an account type or an account group, which defines a set of access permission of the accounts belonging to that type or group. For example, an account may be designated as an administrator account or a user account, based on which the account has different permissions associated with it. As a further example, an account may be associated with a group designation, such as “professor,” “facilities management,” “IT staff,” or “student,” based on which the account is associated with different permissions.

### Method for Remotely Managing Multi-Stream Recordings

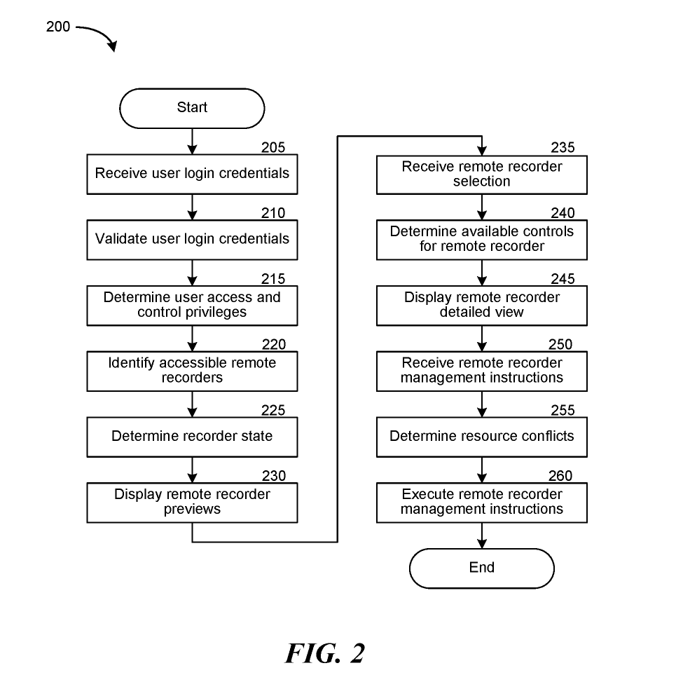

FIG. 2 illustrates an example process 200, implemented by the multi-stream recorder remote management system described above with reference to FIG. 1 or another suitable system, for managing remote multi-stream recorders. The process 200 may be implemented on a remote management device running a remote management application and on a remote management server in communication with the remote management device, as illustrated in FIG. 1, although other devices and combinations may be used.

Beginning at block 205, the system receives login credentials with which to authenticate a user. The login credentials may be provided by the user through the mobile application running on the remote management device. The login credentials may be, for example, a username and password associated with the remote management system, a username and password associated with a third-party user account (e.g., a university or corporate login), or a user voice command.

At block 210, the system validates the received user login credentials. By validating the credentials, thereby authenticating the user, the multi-stream recorder remote management system may ensure that only authorized users are able to access the remote management system. Furthermore, as described herein, requiring the login to a user account (associated with the user login credentials) enables the system to determine access rights, user preferences, and other information associated with the user, based on which the system may enforce fine-grained access controls.

When login credentials are in the form of a username and password, the system verifies that the username and password are valid. For example, the system may compare the received username and password with a list maintained by the system or by a third-party authentication server. If the system detects a match, then the user is logged in to the user account with the username provided by the user.

When login credentials are in the form of a voice command, the system may use voice-recognition to verify the user. For example, the system may maintain voice data of authorized users. The voice data may have been previously provided by authorized users for the purpose of voice-recognition training. When a voice command to log in to the system is received, the system compares the received voice data to the maintained voice data of authorized users. If the system detects a voice match, then the user is logged in to a user account associated with the maintained voice data.

Once the user has logged in, the process 200 continues at block 215 and determines the access and control privileges associated with the authenticated user. As described herein, the access and control privileges describe, for individual user accounts as well as the account types and account groups to which the user accounts may belong, which remote multi-stream recorders are allowed to be accessed by the user and which control functions are available to the user over those recorders. The access and control privileges may, for example, be maintained by the system as part of user account storage. As part of the operation of block 215 the system may retrieve the relevant maintained permissions (e.g., account-level permissions for the authenticated user as well as the permissions for the types or groups to which the account belong), and based on the retrieved permissions, determine the access and control privileges for the user.

The user access and control privileges provide fine-grain access controls that enable only certain multi-stream recorders to be accessible to a user, and optionally, only when certain conditions are met. Such fine-grain controls may previously have been set by an administrator of the system. For example, an administrator may enable different multi-stream recorders for use on a user-by-user or group-by-group (i.e., students, guest lecturers, professors, physics department professors, math department professors, etc.) basis. That is, by way of example, an administrator may configure the system such that all individuals associated with the physics department of a university have access to one set of multi-stream recorders, all physics professors have access to a different set of multi-stream recorders, and a specific individual (e.g., the physics department head) has access to a third set of multi-stream recorders. The system thus enables the use of specific multi-stream recorders by specific users or groups of users of the system.

The user access and control privileges may specify additional criteria or limitations on when multi-stream recorders are accessible, which may be set on a recorder-by-recorder basis, a system-wide basis, or a combination thereof. For example, multi-stream recorders may be configured to only be accessible to certain users or groups at specified days or times. Thus, a multi-stream recorder may be configured so that it is accessible to professors at all times of the day, but accessible to students only during limited evening hours (such as when a student group is hosting a presentation). As a further example, multi-stream recorders may be further configured to be accessible based on the detected location of the remote management device being used by the user. Thus a multi-stream recorder may be identified as accessible to a user when the user is located in the same room or building of the multi-stream recorder, but not otherwise. As a still further example, the user access and control privileges may indicate whether a user has certain access rights to an in-use multi-stream recorder. For example, a first user may be permitted to manage any on-site multi-stream recorder, even when the recorder is currently being used (e.g., an administrator), while a second user may only be permitted to manage on-site multi-stream recorders that are idle.

At block 220 the system identifies the multi-stream recorders that are accessible to the logged-in user. As described herein, the multi-stream recorders accessible to the user may be based on access and control privileges associated with the user. For example, the user may be given access to a selection of multi-stream recorders associated with an entity (e.g., a university), and the accessible recorders (as determined by the block 220) may be further conditions by whether the user is currently on-site, whether it is currently day time or after-hours, etc.

At block 225, the system determines the recorder state, or operational status, of the accessible multi-stream recorders. For example, for each of the accessible multi-stream recorders the system may determine whether there is any activity at the recorder, such as whether the recorder is currently recording or idle. As a further example, for each of the accessible multi-stream recorders the system may determine whether there are any configuration, connectivity, or other issues with the multi-stream recorder, such as whether the recorder is offline, has lost a video feed, has lost an audio feed, etc.

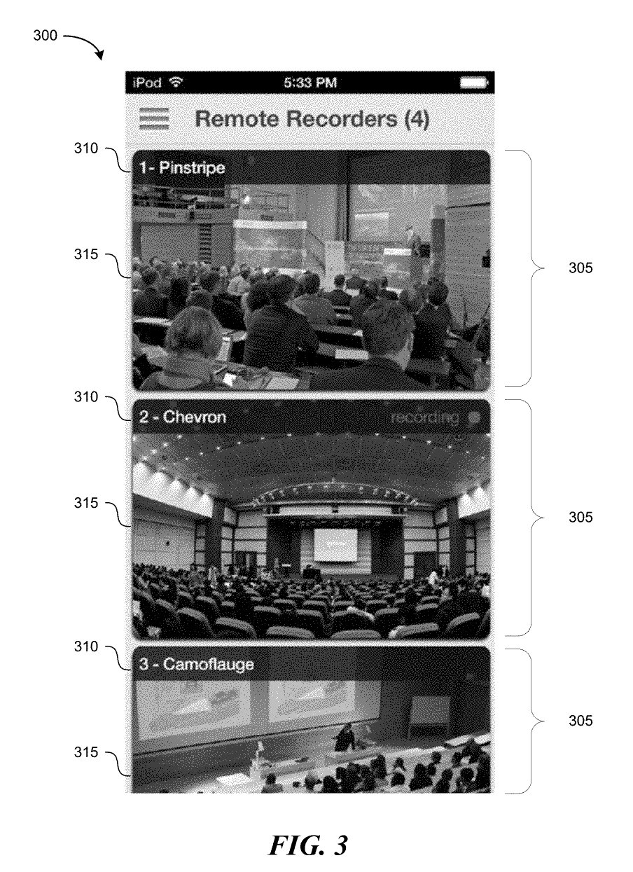

At block 230, the system displays a preview of the accessible remote multi-stream recorders. In some embodiments, and for some categories of users, the system only displays previews of the accessible multi-stream recorders that were determined to be idle. For example, a non-administrator user may not receive a preview of a multi-stream recorder that is currently recording. FIG. 3 illustrates an example graphical user interface 300, such as part of a mobile application running on a remote management device, through which previews of the accessible multi-stream recorders may be displayed. The interface 300 includes a preview 305 of each of multi-stream recorders accessible to the user. Although three previews 305 are shown, it will be appreciated that a different number of previews 305 may be available. Each preview 305 may include an information bar 310 providing information on the multi-stream recorder. For example, the information bar 310 may include a name and/or number identifying the multi-stream recorder. The name may correspond to the name of the location at which the recorder is located (e.g., the name of a lecture hall or conference room) or any other identifier that may uniquely identify the multi-stream recorder to a user. The information bar 310 may also include status information, such as whether or not the multi-stream recorder is currently recording. Each preview 305 may also include a preview image 315. The preview image 315 may be captured from one of the content recorders that make up the multi-stream recorder, and provides the user with a preview of the multi-stream recorder content. The preview image 315 displayed in the interface 300 may be updated periodically, such as every 10 seconds. If a multi-stream recorder is busy (e.g., recording) but is nonetheless identified as accessible to the user, then the preview 305 of the busy multi-stream recorder may not include a preview image 315. For example, a black image or a stock image associated with recorder may be used in place of an updating preview image 315. Though not illustrated in FIG. 3, the displayed preview may additionally include operational status for each of the displayed multi-stream recorders (such as determined by the block 225). The display of operational status allows a user (e.g., a remote administrator) to easily see whether any of the remote recorders they oversee have a problem.

Referring back to FIG. 2, the process 200 continues at block 235 and the system receives from the user a selection of one of the displayed multi-stream recorders. For example, the mobile application may detect a touch input to the remote management device corresponding to the preview of one of the multi-stream recorders. As a further example, the mobile application may detected a voice command from the user indicating the user has selected one of the multi-stream recorders, such as by identifying the multi-stream recorder by unique name or number.

At block 240, the system determines which management controls are available to the user for the selected multi-stream recorder. As described herein, management controls may be associated with a recording at the multi-stream recorder (e.g., start recording, pause recording, stop recording, enable or disable stream in the recording, etc.), associated with the configuration of the multi-stream recorder itself (e.g., add or remove device streams to the multi-stream recorder, change multi-stream recorder description, etc.), or other. The available control may be based on, for example, the determined user access and control privileges of the user.

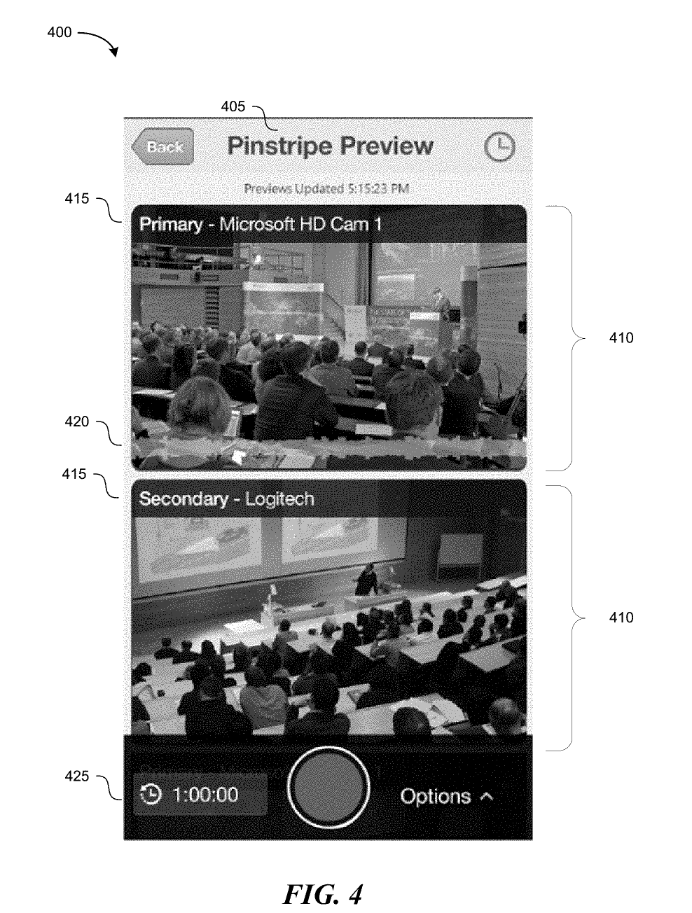

At block 245, the system displays a detailed view of the selected multi-stream recorder. The detailed view of the selected multi-stream recorder may be based on the recorder controls available to the user. FIG. 4, for example, illustrates an example graphical user interface 400, such as part of a mobile application running on a remote management device, through which a detailed view of the selected multi-stream recorder may be displayed. The interface 400 includes title information 405, such as the name of selected multi-stream recorder. The interface 400 includes a preview 410 of each of the content recorders that make up the multi-stream recorder. Each preview 410 includes an information bar 415 with additional information regarding the content recorder, such as the name of the recording source and whether the content recorder is a primary or secondary source for the multi-stream recorder. Though in the example illustrated by FIG. 4 both sources are cameras (e.g., MICROSOFT® HD cameras), the source may also be content displayed on a computer being used as a content recorder (e.g., a webpage or presentation slides).

The interface 400 may also include a preview image and audio histogram 420 for one or more of the content recorders making up the multi-stream recorder. The audio histogram 420 reflects audio that has been detected in the vicinity of the content recorder, such as audio picked up by a microphone paired to the content recorder. The audio histogram 420 may, for example, provide confirmation that audio is being captured correctly by the content recorder. By providing a preview image and audio histogram for each of the content recorders of the multi-stream recorder, the system enables users to quickly preview what would be captured by a recording at the multi-stream recorder, and provides them with confidence in any subsequent remote recording.

Referring back to FIG. 2, at block 250, the system receives management instructions from the user for the selected multi-stream recorder. Management instructions may be received from the user, for example, via touch inputs or voice controls. For example, the user may initiate a recording at the multi-stream recorder by interacting with, for example, the recording configuration area 425 such as illustrated in FIG. 4. The user may additionally provide a recording duration. When the user provides a recording duration, the system may check the schedule of recordings for the multi-stream recorder to determine whether a recording of the indication duration will conflict with any scheduled recordings. If there is a conflict the user may be notified, such as through an application message. The user may provide additional configuration options for the recording. For example, the user may provide a title for the recording session. The user may also specify a location at which to save the recording. If no location is specified by the user, the system may save the recording to a default location associated with the user. The user may also use voice commands to start a recording in addition to the interface 400 illustrated in FIG. 4. Recorder management instructions other than those directed to initiating a new multi-stream recording may be received from the user. For example, as described herein, the management instructions may be directed to managing a current recording or configuring the multi-stream recorder.

At block 255, the system determines whether there are any resource conflicts associated with the management instruction received for the selected multi-stream recorder. Conflicts may occur, for example, when a user (such as a non-administrator) attempts to enact a chance to the recording schedule of the multi-stream recorder that interferes with a pre-existing scheduled recording. For example, the multi-stream recorder may be in-use and recording for another user. As a further example, the multi-stream recorder may be scheduled to begin a recording for another user within a threshold time from the present time. The system may use scheduling data maintained by the system to determine whether a multi-stream recorder is busy. By identifying management conflicts, the system can enforce rules regarding the management of busy recorders by different users. For example, for certain categories of users (e.g., end users), the system may prevent the execution of management instructions that would cause a conflict, and may additionally suggest alternative instructions that would not lead to a conflict (e.g., a shorter recording length or different recording time). As a further example, for certain categories of users (e.g., administrators), the system may allow the received management instruction to take priority over previously-scheduled activity at the multi-stream recorder.

At block 260, the system executes the received management instructions. For example, the system may begin a recording session at the multi-stream recorder based on the instructions received from the user. Additionally, the system may update system data, such as updating shared scheduling data maintained by the system when a new recording is scheduled or initiated. By doing so, the multi-stream recorder will no longer appear as available to other users of the system at the scheduling time indicated by the user. In this manner, the system provides use-based sharing of the shared multi-stream recorder resources.

Multi-Stream Recorder Remote Management Functions

As described herein, the multi-stream recorder remote management system provides a variety of management functions over remote multi-stream recorders. For example, the system may provide management functions over recordings (whether past, current, or scheduled), over the remote recorders, and other. A user may be provided access to different management functions over different multi-stream recorders and recordings depending on the privileges associated with the user. For example, some users may be provided access to recording functions only over their own recordings, while other users (e.g., administrators) may be provided access to recording functions over all recordings, as well as recorder functions over the recorder itself. The following is a brief description of some management functions which may be provided by some embodiments of the system. It will be appreciated that other management functions may be provided by the multi-stream recorder remote management system.

The remote management system may provide a number of functions to facilitate the management of recordings. For example, the system may enable a user to schedule a future recording at a remote recorder. The system may also enable the user to start a new recording (i.e., approximately immediately) at the remote recorder, or to start a scheduled recording early. Active recordings may be configured to be saves to a storage area and/or to be webcast live. When scheduling a recording or starting a recording, the system may verify that the recording to be started does not overlap with any previously scheduled recordings at the remote recorder. In addition to functions for scheduling and starting recordings, other management functions are provided by the system. For example, the system may enable a user to stop a recording, as well as enable the user to pause and resume the recording. Different recording functions, such as starting, stopping, pausing, and resuming may be provided on a per-stream basis, thereby enabling the user to separately control the different streams of the multi-stream recording.

The recording management may additionally enable the addition of supplemental or meta content to an active or scheduled recording. For example, the system may enable a user to create “attention points” or a table of contents of noteworthy moments during a recording. The system may enable a user to provide a live transcription of the recording. The system may also enable a user to moderate audience questions regarding the active stream. The system may additionally enable the user to specify information regarding the recording (e.g., recording title, recording description, etc.). Based on the access and control privileges associated with the users, some users may only be permitted to manage their own recordings, while other users may be permitted to manage all scheduled or active recordings. Additionally, the access and control privileges may grant access to different functions within a recording. That is, for example, one user (e.g., a “recording manager”) may be allowed to control all aspects of a recording, while a second user (e.g., a “moderator”) may only be allowed to interact with audience questions, and a third user (e.g., a “transcriber”) may only be allowed to create and modify recording transcriptions.

The remote management system may additionally provide a number of functions to facilitate the management of the multi-stream recorders. For example, the system may enable a user to monitor, but not modify, the current recording activity of the recorder. The system may also enable a user to configure the recorder. For example, the user can modify the description of the recorder, which devices are used by the recorder (corresponding to the different streams), etc.

### CONCLUSION

The above descriptions of examples of the disclosed technology are not intended to be exhaustive or to limit the disclosed technology to the precise form disclosed above. While specific embodiments of, and examples for, the disclosed technology are described above for illustrative purposes, various equivalent modifications are possible within the scope of the disclosed technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative combinations or subcombinations. Each of these processes or blocks may be implemented in a variety of different ways. Also, while processes or blocks are at time shown as being performed in series, these processes or blocks may instead be performed or implemented in parallel, or may be performed at different times. Further, any specific numbers noted herein are only examples; alternative implementations may employ differing values or ranges.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Where the context permits, singular or plural terms may also include the plural or singular term, respectively. Additionally, the term “comprising” is used throughout to mean including at least the recited feature(s) such that any greater number of the same feature and/or additional types of other features are not precluded. It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

I/we claim:

1. A computer-implemented method for remotely managing a multi-stream recording from a mobile device, the method comprising:
receiving, at the mobile device, a first user input, wherein the first user input identifies a user account;
displaying, at the mobile device, information for one or more remote multi-stream recorders accessible to the user account;
receiving, at the mobile device, a second user input, wherein the second user input indicates a remote multi-stream recorder, selected from the displayed one or more remote multi-stream recorders;
displaying, at the mobile device, one or more available management functions for the selected remote multi-stream recorder;
receiving, at the mobile device, a third user input, wherein the third user input indicates a management function, selected from the displayed one or more available management functions, to be performed at the selected remote multi-stream recorder; and
performing the selected management function at the selected remote multi-stream recorder.

2. The method of claim 1 wherein the one or more remote multi-stream recorders accessible to the user account are based on access privileges of the user account, the location of the mobile device, or the day and time at which the first user input is received.

3. The method of claim 1 wherein the one or more remote multi-stream recorders accessible to the user account is determined by a computing system distinct from the mobile device.

4. The method of claim 1 wherein displaying information for the one or more remote multi-stream recorders comprises displaying a preview image for each remote multi-stream recorder.

5. The method of claim 1 wherein the displayed information is based on permissions associated with the identified user account.

6. The method of claim 1, further comprising displaying, at the mobile device, a preview image for each recording device associated with the selected remote multi-stream recorder.

7. The method of claim 1 wherein the one or more management functions available to the user account are based on control privileges of the user account, the location of the mobile device, or the day and time at which the second user input is received.

8. The method of claim 1 wherein the user account is associated with a user group, and wherein the one or more multi-stream recorders accessible to the user and the one more management functions available to the user are based on the associated user group.

9. The method of claim 1 wherein the one or more available management functions comprises one or more of scheduling a future recording at the selected remote multi-stream recorder, starting a recording at the selected remote multi-stream recording, pausing a recording at the selected remote multi-stream recorder, resuming a paused recording at the selected remote multi-stream recorder, or stopping a recording at the selected remote multi-stream recorder.

10. The method of claim 1 wherein the one or more available management functions comprises one or more of monitoring recording activity at the selected remote multi-stream recorder or configuring the selected remote multi-stream recorder.

11. The method of claim 10 wherein configuring the selected remote multi-stream recorder comprises selecting one or more recording devices to associated with the remote multi-stream recorder.

12. A non-transitory computer-readable medium containing instructions configured to cause one or more processors to perform a method for remotely managing a multi-stream recording, the method comprising:
receiving, at a mobile device, a first user input, wherein the first user input identifies a user account;
displaying, at the mobile device, information for one or more remote multi-stream recorders accessible to the user account;
receiving, at the mobile device, a second user input, wherein the second user input indicates a remote multi-stream recorder, selected from the displayed one or more remote multi-stream recorders;
displaying, at the mobile device, one or more available management functions for the selected remote multi-stream recorder;
receiving, at the mobile device, a third user input, wherein the third user input indicates a management function, selected from the displayed one or more available management functions, to be performed at the selected remote multi-stream recorder; and
performing the selected management function at the selected remote multi-stream recorder.

13. The non-transitory computer-readable medium of claim 12, wherein the one or more remote multi-stream recorders accessible to the user account are based on access privileges of the user account, the location of the mobile device, or the day and time at which the first user input is received.

14. The non-transitory computer-readable medium of claim 12, the method further comprising displaying, at the mobile device, a preview image for each recording device associated with the selected remote multi-stream recorder.

15. The non-transitory computer-readable medium of claim 12, wherein the one or more management functions available to the user account are based on control privileges of the user account, the location of the mobile device, or the day and time at which the second user input is received.

16. The non-transitory computer-readable medium of claim 12, wherein the user account is associated with a user group, and wherein the one or more multi-stream recorders accessible to the user and the one more management functions available to the user are based on the associated user group.

17. The non-transitory computer-readable medium of claim 12, wherein the one or more available management functions comprises one or more of scheduling a future recording at the selected remote multi-stream recorder, starting a recording at the selected remote multi-stream recording, pausing a recording at the selected remote multi-stream recorder, resuming a paused recording at the selected remote multi-stream recorder, or stopping a recording at the selected remote multi-stream recorder.

18. The non-transitory computer-readable medium of claim 12, wherein the one or more available management functions comprises one or more of monitoring recording activity at the selected remote multi-stream recorder or configuring the selected remote multi-stream recorder.

19. The non-transitory computer-readable medium of claim 18, wherein configuring the selected remote multi-stream recorder comprises selecting one or more recording devices to associated with the remote multi-stream recorder.

20. A system for remotely managing a multi-stream recording, the system comprising:
a mobile device, the mobile device configured to:
receive a first user input, wherein the first user input identifies a user account;
display information for one or more remote multi-stream recorders accessible to the user account;
receive a second user input, wherein the second user input indicates a remote multi-stream recorder, selected from the displayed one or more remote multi-stream recorders;
display one or more available management functions for the selected remote multi-stream recorder; and
receive a third user input, wherein the third user input indicates a management function, selected from the displayed one or more available management functions, to be performed at the selected remote multi-stream recorder; and
a multi-stream recorder, the multi-stream recorder configured to:
perform a management function received from a remote device.
